(19) United States
(12) Patent Application Publication
(10) Pub. No.: US 2006/0103111 A1
(43) Pub. Date: May 18, 2006

(54) Trailer hitching apparatus

(76) Inventor: Brian E. Popham, Smyma, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/235,849

(22) Filed: Sep. 27, 2005

Related U.S. Application Data
(63) Continuation-in-part of application No. 10/739,734, filed on Dec. 17, 2003, now Pat. No. 6,922,950.
(63) Continuation-in-part of application No. 10/739,604, filed on Dec. 18, 2003, now Pat. No. 6,948,734.
(60) Provisional application No. 60/456,061, filed on Mar. 20, 2003.

(51) Int. Cl. B60D 1/40

(52) U.S. Cl. 280/478.1

(57) ABSTRACT

A trailer hitching apparatus comprises a trailer hitch receiver assembly, a winching device, a trailer hitch and a cable. The trailer hitch receiver assembly includes a receiver tube having a first end, a second end, an opening at the second end, and a passage extending from the opening toward the first end. The cable extends through the opening. The trailer hitch receiver assembly is mountable on a chassis of a vehicle. The winching device is mountable on at least one of the chassis of the vehicle and the trailer hitch receiver assembly. The trailer hitch includes a receiver stub configured for being engaged within the receiver tube through the opening at the second end of the receiver tube. The cable has a first end attached to a spool of the winching device and a second end attached to the receiver stub of the trailer hitch. When the cable is wound onto the spool of the winch, while the receiver stub of the trailer hitch is correspondingly pulling into the passage of the receiver tube, thereby engaging the trailer hitch within the trailer hitch receiver assembly.

### CROSS REFERENCE TO RELATED APPLICATIONS

This application is a Continuation-In-Part of U.S. patent application Ser. No. 10/739,604 filed on Dec. 18, 2003 entitled TRAILER HITCHING APPARATUS, which in turn claims the benefit of U.S. Provisional Patent Application Ser. No. 60/456,061 filed Mar. 20, 2003 entitled “Winch-N-Hitch”.

### FIELD OF THE DISCLOSURE

The present invention relates generally to trailer hitches and trailer hitch receivers, and more particularly to arrangements for hitching a trailer to a tow vehicle.

### BACKGROUND OF THE INVENTION

Connecting a tongue of a trailer to a trailer hitch of a tow vehicle using conventional approaches can be difficult. This is particularly true when the trailer cannot be readily manipulated by hand. For example, when the weight of a trailer and/or the orientation of the trailer (e.g., on an incline) is such that the trailer cannot be readily moved by hand for facilitating connection of the tongue of the trailer to the trailer hitch, the tow vehicle must be backed to either a position with the trailer hitch aligned under the tongue of the trailer or a position where only slight manual maneuvering of the trailer is required to align the trailer hitch with the tongue of the trailer.

For several reasons, such conventional approaches for connecting a tongue of trailer to a trailer hitch of a tow vehicle often require two people. Typically, a first person backs the vehicle under direction of a second person. The directions from the second person aid in aligning the trailer hitch to the tongue of the trailer and in precluding the tow vehicle from being accidentally backed into the tongue of the trailer. In some cases, such conventional approaches require two people because one person has to maneuver and hold the trailer in position (i.e., the tongue aligned over the trailer hitch) while a second person lowers the tongue of the trailer (e.g., via a hand crank) onto a ball of the trailer hitch.

Therefore, a trailer hitching apparatus that overcomes limitations associated with conventional trailed hitch assemblies and trailer-hitching approaches would be useful and advantageous.

### SUMMARY OF THE INVENTION

Briefly described, in a first preferred form the present invention is an attachment that can be added to a vehicle to make it easier to secure a trailer to a trailer hitch. A receiver hitch is mounted to the vehicle, along with a winch. A cable from the winch extends through the receiver tube portion of the receiver hitch and is attached to the receiver stub. The winch can be operated to allow one to draw out the receiver stub from the receiver tube. The receiver stub is then attached to the trailer while extended from the receiver tube. After securing the receiver stub to the trailer, the winch is operated again to draw the receiver stub back into the receiver tube.

Advantageously, this eliminates the need to precisely align the trailer with the hitch. The winch draws the receiver stub back into the receiver tube, despite some misalignment with the trailer.

Preferably, the “nose” of the receiver stub is tapered (and/or the opening in the receiver tube is tapered) to help guide and ease the receiver stub back into the receiver tube despite less than perfect alignment.

Optionally, the winch can be situated to be in line with the receiver tube so that the cable is pulled straight in. Optionally, in order to avoid an under-vehicle spare tire (or for other space considerations), the cable can be diverted by a pulley so that the winch is offset by an angle.

The invention can be provided on new vehicles during manufacturing or can be retrofitted to existing vehicles.

The present invention allows a person to attach a trailer to a vehicle, even if the operator of the vehicle doesn't have the strength to manipulate the trailer into final position (as is often needed in the prior art) and doesn't require precise alignment of the vehicle to the trailer. This makes attaching the trailer easier, safer, and more reliable.

### BRIEF DESCRIPTION OF THE DRAWINGS

FIG. 1 is a perspective view of a trailer hitching apparatus according to a first preferred form of the invention.

FIG. 2 is a cross-sectional view of the trailer hitching apparatus of FIG. 1 taken along the line 2-2 in FIG. 1.

FIG. 3 is a perspective view of a trailer hitching apparatus according to a second preferred form of the invention.

FIG. 4 is a plan view of a trailer hitching apparatus according to a third preferred form of the invention.

FIG. 5 is a cross-sectional side view of a trailer hitching apparatus according to a fourth preferred form of the invention.

FIG. 6 is a cross-sectional side view of a trailer hitching apparatus according to a fifth preferred form of the invention.

### DETAILED DESCRIPTION

Apparatuses and methods in accordance with embodiments of the disclosures made herein are configured for engaging a trailer hitch with a trailer hitch receiver using a winching device. Such apparatuses and methods are configured for overcoming limitations associated with conventional trailer hitch assemblies and trailer-hitching approaches. The present invention allows a trailer that cannot be moved readily by hand to be connected to a tow vehicle by a single person in a relatively easy, safe and simple manner.

Apparatuses and methods in accordance with embodiments of the disclosures made herein are particularly advantageous and useful when a trailer that needs to be hitched to a tow vehicle cannot be readily manipulated by hand (e.g., manually rolled or pushed). In instances where the weight of the trailer and/or the orientation of the trailer (e.g., on an incline) is such that the trailer cannot be readily moved by hand for facilitating connection of the tongue of the trailer to the trailer hitch, such apparatuses and methods allow a single person to connect the trailer to the tow vehicle easily, safely and simply. Specifically, with the tow vehicle in a backed position achievable by a single person (i.e., backed into an approximate vicinity of the trailer without being directed by a second person), such apparatuses and methods allow the tow vehicle and trailer to be mechanically drawn into engagement with each other. Accordingly, such apparatuses and methods dramatically reduce the potential for damage to the tow vehicle and trailer and the potential for human injury during the trailer hitching process.

In one embodiment of the disclosures made herein, a trailer hitching apparatus comprises a trailer hitch receiver assembly, a winching device and a cable. The trailer hitch receiver assembly includes a receiver tube having a first end, a second end, an opening at the second end, and a passage extending from the opening toward the first end. The cable has a first end thereof configured for being attached to a spool of the winching device and a second end thereof configured for being connected to a receiver stub of a trailer hitch. At least one of the ends of the cable is configured for enabling the cable to be routed through the opening at the second end of the receiver tube thereby enabling the cable to be wound onto the spool of the winch while correspondingly pulling the receiver stub of the trailer hitch into the passage of the receiver tube. The winching device can be mounted on the chassis of the vehicle or the trailer hitch receiver assembly. Optionally, the trailer hitch receiver assembly can include a plurality of guide members mounted within the opening for aiding in engagement of the receiver stub within the receiver tube. A cable guide member is attached to the trailer hitch receiver assembly and the cable is partially wrapped around a circumference of the cable guide member for enabling the cable to be directed toward the spool of the winching device.

In another embodiment of the disclosures made herein, a trailer hitching apparatus comprises a trailer hitch receiver assembly, a winching device, a trailer hitch and a cable. The trailer hitch receiver assembly is mountable on a chassis of a vehicle and includes a receiver tube having a first end, a second end, an opening at the second end, and a passage extending from the opening toward the first end. The winching device is mountable on at least one of the chassis of the vehicle and the trailer hitch receiver assembly. The trailer hitch includes a receiver stub configured for being engaged within the receiver tube through the opening at the second end of the receiver tube. The cable has a first end thereof attached to a spool of the winching device and a second end thereof attached to the receiver stub of the trailer hitch. The cable extends through the opening of the receiver tube. A first end of the receiver stub is tapered for aiding in engagement with the receiver tube.

The receiver stub includes a plurality of pin engaging holes formed therethrough. A first one of the pin engaging holes is positioned adjacent to a receiver tube engaging end of the receiver stub and a second one of the pin engaging holes is positioned adjacent to a tongue mounting end of the receiver stub. The second end of the cable is attached to a pin extending through the second one of the pin engaging holes. The trailer hitch includes a stop member attached thereto for limiting an insertion depth of the receiver stub within the receiver tube such that the first one of the pin engaging holes is approximately aligned with a mating hole at the second end of the receiver tube when the stop member contacts the receiver tube. A cable guide member is attached to the trailer hitch receiver assembly with the cable being partially wraps around a circumference of the cable guide member for enabling the cable to be directed toward the spool of the winching device. When the winch is activated for winding the cable onto the spool of the winch, the receiver stub of the trailer hitch is correspondingly pulled into the passage of the receiver tube.

In another embodiment of the disclosures made herein, a method for engaging a trailer hitch with a trailer hitch receiver comprises extending a cable through a receiver stub opening in a receiver tube of a trailer hitch receiver assembly, attaching a first end of the cable to a winching device, wrapping the cable partially around a circumference of the cable guide member for enabling the cable to be directed toward the spool of the winching device, attaching a second end of the cable to a receiver stub of a trailer hitch and operating the winching device for winding the cable onto the spool of the winching device thereby pulling the receiver stub of the trailer hitch, which is attached to the tongue of the trailer, into the passage of the receiver tube. The receiver tube includes a first end and a second end, and extending the cable through the receiver stub opening includes extending the cable through a passage of the receiver tube that extends from the receiver stub opening toward the first end of the receiver tube.

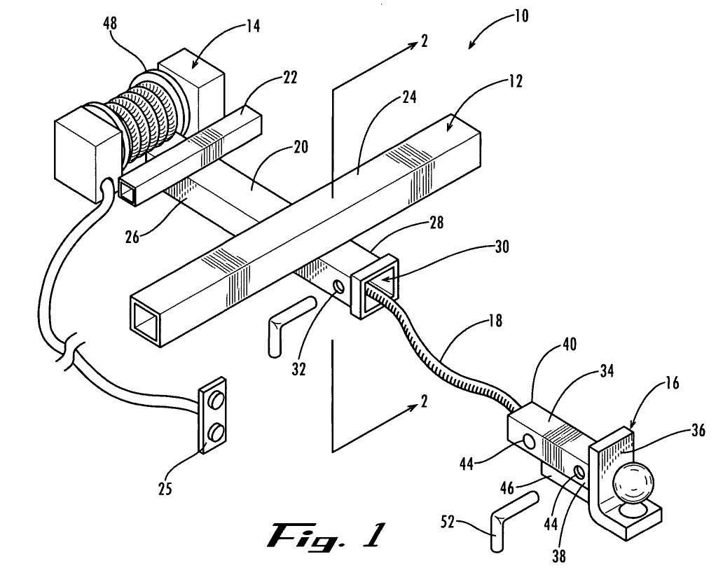

Turning now to the drawing figures, a trailer hitching apparatus 10 in accordance with an embodiment of the disclosures made herein is depicted in FIG. 1. The trailer hitching apparatus 10 comprises a trailer hitch receiver assembly 12, a winching device 14, a trailer hitch 16 and a cable 18. The trailer hitch receiver assembly 12 includes a receiver tube 20, a first mounting member 22 and a second mounting member 24. The trailer hitch receiver assembly 12 is mountable on a chassis of a tow vehicle via the first and second mounting members 22, 24 using commercially available fastening components (e.g., nuts, bolts and backing plates).

The winching device 14 is mountable on at least one of the chassis of the vehicle (not specifically shown) and the trailer hitch receiver assembly 12 (e.g., on the first end of the receiver tube 20). As depicted in FIG. 1, the winching device 14 is electrically powered and includes a winch control unit 25, which may be fixedly mounted on a rear portion of the tow vehicle (e.g., the bumper), fixedly mounted within a cabin of the tow vehicle, or detachably mounted for allowing it to be portable. It is contemplated herein that the winching device 14 may be an electrically-powered winching device or a hand-operated winching device. Optionally, the trailer hitch receiver assembly 12 can be welded to the vehicle frame.

The receiver tube 20 has a first end 26, a second end 28, an opening 30 (i.e., a receiver stub opening) at the second end 28, a lock pin hole 32 extending through opposing walls adjacent the second end, and a passage 33 extending from the opening 30 toward the first end 26. The first mounting member 22 is attached to the receiver tube 20 in a transverse orientation adjacent the first end 26 of the receiver tube 20. The second mounting member 24 is attached to the receiver tube 20 in a transverse orientation adjacent the second end 28 of the receiver tube 20.

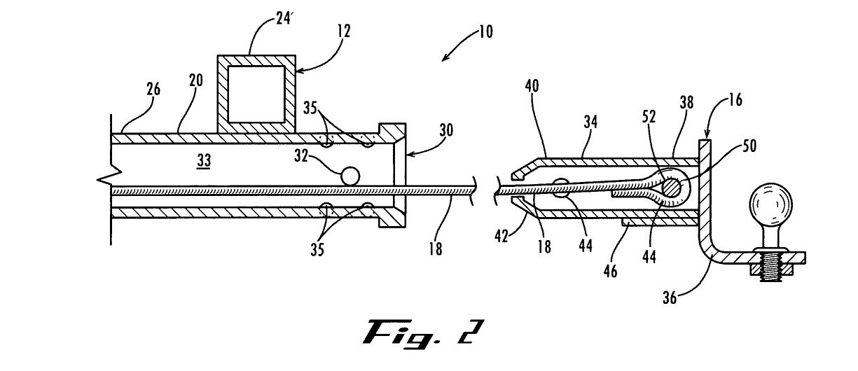

The trailer hitch 16 includes a receiver stub 34 and a ball mounting flange 36. The ball mounting flange 36 is attached to the receiver stub 34 at a tongue mounting end 38 (i.e., a first end) of the receiver stub 34. A receiver tube engaging end 40 (i.e., a second end) of the receiver stub 34 has tapered faces 42 for aiding in engagement of the receiver stub 34 with the receiver tube 20. As shown in FIG. 1, it is contemplated herein that the surfaces of the passage 33 that define the opening 30 may be tapered, and as shown in FIG. 2, the surfaces can have optional guide members 35, preferably in the form of rollers mounted therein for further aiding in engagement of the receiver stub 34 with the receiver tube 20.

The receiver stub 34 includes a plurality of pin engaging holes 44 formed through opposing faces of the receiver stub 34. A first one of the pin engaging holes 44 is positioned adjacent to the receiver tube engaging end 40 of the receiver stub 34. A second one of the pin engaging holes 44 is positioned adjacent to the tongue mounting end 38 of the receiver stub 34.

A stop member 46 (e.g., a piece of rectangular bar stock) is attached to the receiver stub 34 and/or to the ball mounting flange 36. The stop member 46 is configured for limiting an insertion depth of the receiver stub 34 within the receiver tube such that the first one of the pin engaging holes is approximately aligned with a mating hole at the second end of the receiver tube when the stop member 46 contacts the receiver tube.

The cable 18 has a first end (not specifically shown) attached to a spool 48 of the winching device 14 and a second end 50 thereof attached to the receiver stub 34 of the trailer hitch. The cable 18 extends through the opening 30 and passage 33 of the receiver tube 20. The second end 50 of the cable 18 is attached within the receiver stub 34 to a pin 52 extending through the second one of the pin engaging holes 44 (i.e., the hole closest to the tongue mounting end 38 of the receiver stub 34).

Cable specifications (e.g., load rating) are dependent on the strength necessary for a given application and/or load. Similarly, specifications for winching devices, lock pins and other physical and mechanical aspects/components of trailer hitching apparatuses in accordance with embodiments of the disclosures made herein are dependent upon requirements for particular applications.

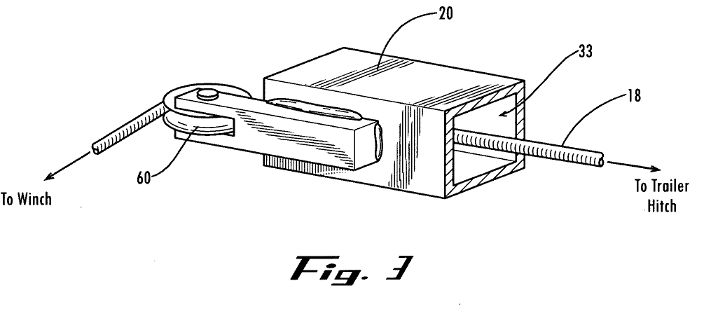

FIG. 3 depicts an embodiment of a cable guiding member 60 attached to the receiver tube 20 of the trailer hitch receiver assembly 12 depicted in FIGS. 1 and 2. A pulley and a roller are examples of the cable guide member 60. As depicted, the cable guide member 60 is attached to the receiver tube 20 adjacent to the first end 26 of the receiver tube 20. The cable 18 is wrapped partially around a circumference of the cable guide member 60 for enabling the cable 18 to be directed toward the spool 48 of the winching device 14. In this manner, placement and orientation of the winching device 14 is not limited to being in-line with the passage 33. For example, through the use of and appropriate orientation of the cable guiding member 60, the winching device 14 may be located to the side, above or below the receiver tube. Exact placement of the cable guiding member 60 is dependent upon placement of the winching device 14.

It is contemplated that the cable guiding member 60 may extend partially through an aperture in a wall of the receiver tube 20 at a location between the first and second ends of the receiver tube 20. In this manner, the cable guiding member 60 facilitated the cable 18 to extend through a wall of the receiver tube 20 (e.g., mid way between the first and second ends 26, 28 of the receiver tube 20. Such an arrangement is useful as it increases the number of potential mounting locations for the winching device 14. It is contemplated that the cable guide member 60 may be fixedly mounted (i.e., rotates about a single axis) or pivotally mounted (i.e., rotates about one of a plurality of instant axes). It is contemplated herein that the cable guide member 60 may be mounted within the passage 33 of the receiver tube 20, on the winching device 14 or an ancillary tube (not specifically shown) of the cable hitching apparatus 10.

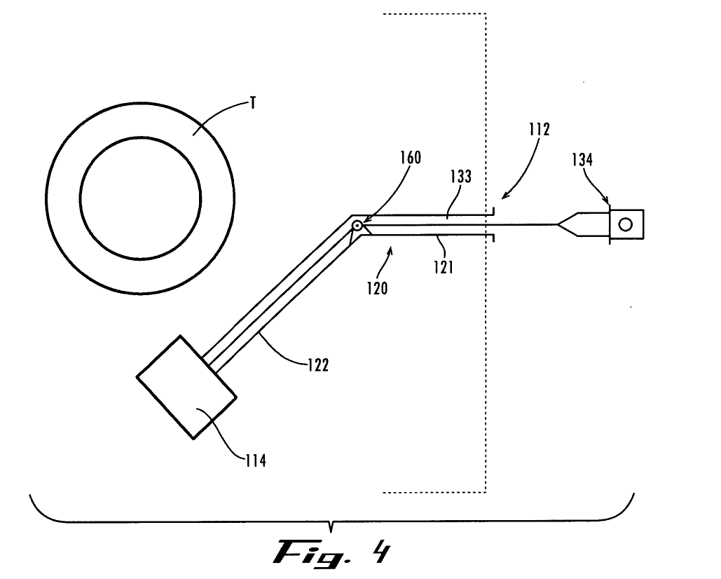

FIG. 4 shows another embodiment of a trailer hitch receiver assembly 112, including a cable guiding member 160 attached to the receiver tube 120 of the trailer hitch receiver assembly 112, similar to that depicted in FIGS. 1 and 2. A pulley and a roller are examples of the cable guide member 160. As depicted, the cable guide member 160 is attached to the receiver tube 120 at a point where the receiver tube 120 transitions from a first part 121 (aligned with the length of the vehicle) to a second part 122 (oriented at an oblique angle thereto). The angled second part 122 provides clearance to avoid an under-vehicle tire T (or other under-vehicle obstruction). This allows the winch 114 to be placed under the vehicle while avoiding the spare tire. In this manner, placement and orientation of the winching device 114 is not limited to being in-line with the passage 133. For example, through the use of an appropriate orientation of the cable guiding member 160, the winch 114 may be located to the side, above or below the receiver tube. In this figure, the dashed lines represent the vehicle bumper.

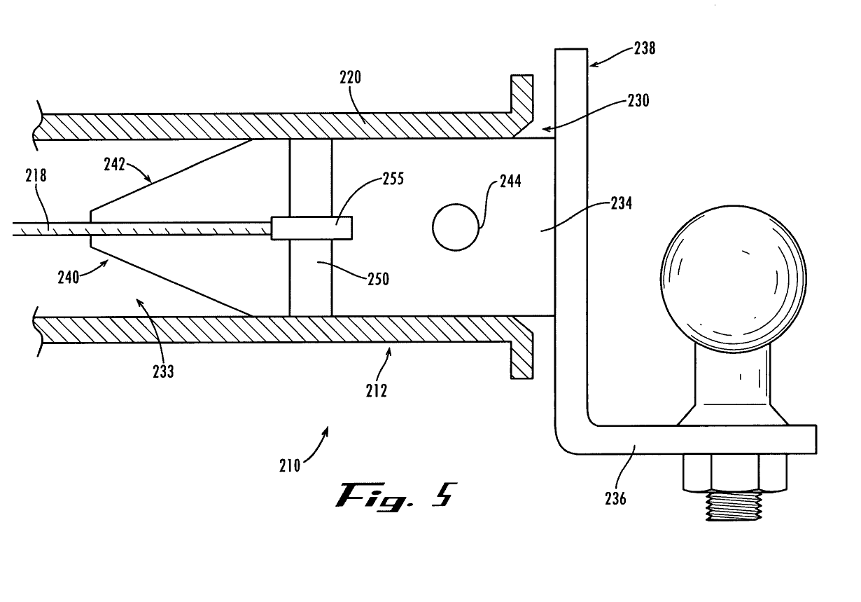

Turning now to FIG. 5, another trailer hitching apparatus 210 is depicted in accordance with the present invention, somewhat similar that which is depicted in FIG. 1. The trailer hitching apparatus 210 comprises a trailer hitch receiver assembly 212, a winching device (unshown in this figure), a trailer hitch 16 and a cable 18. The trailer hitch receiver assembly 212 includes a receiver tube 220. The trailer hitch receiver assembly 212 is mountable on a chassis of a tow vehicle, as described above.

The receiver tube 220 has an open end 28 (near the rearmost portion of the vehicle), an opening 230 (i.e., a receiver stub opening) at the open end 28, and a passage 233 extending from the opening 230 toward the opposite end. The first mounting member 22 is attached to the receiver tube 20 in a transverse orientation adjacent the first end 26 of the receiver tube 220.

The trailer hitch includes a receiver stub 234 and a ball mounting flange 236. The ball mounting flange 236 is attached to the receiver stub 234 at a tongue mounting end 238 (i.e., a first end) of the receiver stub 34. A receiver tube engaging end 240 (i.e., a second end) of the receiver stub 234 has tapered faces 242 for aiding in engagement of the receiver stub 234 with the receiver tube 220. As shown in this figure, it is contemplated herein that the surfaces of the passage 233 that define the opening 30 may be tapered (shown here with a slight chamfer).

The receiver stub 234 includes a cable pin 250 extending thereacross for capturing the end of the cable 218 using a grommet 255 or swaged nut (or other device). Notably, the cable pin 250 is positioned between the nose end (tapered end) 240 of the receiver stub 234 and the pin hole 244, adding to the stability of the receiver stub 234 as it is drawn back into the receiver tube 220.

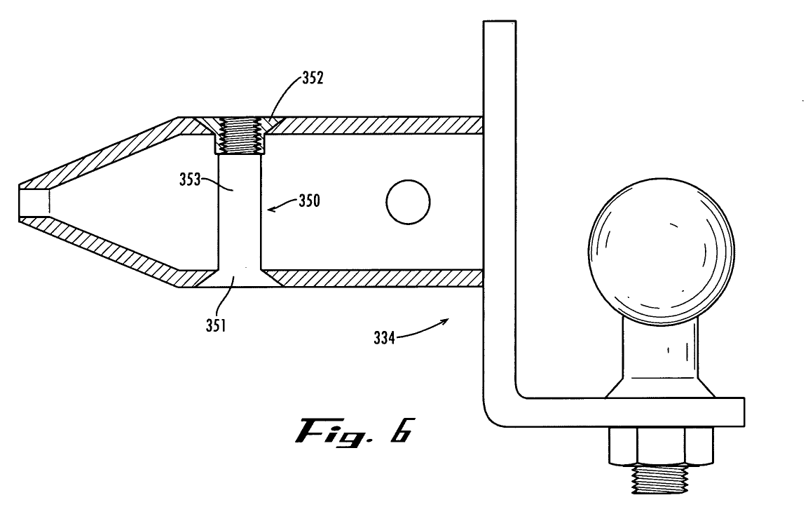

Referring now to FIG. 6, another form of the receiver stub of FIG. 5 is shown. In this embodiment, the receiver stub 334 has a tapered nose end 340, similar to FIG. 5. However, in this embodiment, the cable pin 350 is formed from a screw 351 and a nut 352. The screw 351 and nut 352 are countersunk into the sides (or top and bottom) of the receiver stub 334. The screw 351 includes a smooth shank 353 for receiving a collar, nut or other cable connector therearound. Of course, the end of the screw 351 is threaded into the nut 352. Advantageously, this arrangement allows the receiver stub to be removed from and reattached to the cable. One advantage to this arrangement is that is it allows other stub accessories to be used. For example, the receiver stub with a ball hitch can be replaced with a receiver stub carrying an eyelet for attaching a hook (such as for securing a chain, cable or rope thereto).

In operation, apparatuses in accordance with embodiments of the disclosures made herein provide for a novel useful and advantageous method for engaging a trailer hitch with a trailer hitch receiver to be carried out. The method includes extending a cable through a receiver stub opening in a receiver tube of a trailer hitch receiver assembly, attaching a first end of the cable to a winching device, attaching a second end of the cable to a receiver stub of a trailer hitch and attaching the trailer hitch to the tongue of a trailer. With the receiver stub at a lower height than that of the receiver tube, the winching device is then operated such that the cable is wound onto the spool of the winching device thereby pulling the receiver stub of the trailer hitch, which is attached to the tongue of the trailer, into the passage of the receiver tube. A lock pin may then be inserted through the receiver tube and receiver stub for securing them together. Accordingly, apparatuses and methods in accordance with embodiments of the disclosures made herein allow a trailer that cannot be readily moved by hand to be connected to a tow vehicle by a single person in a relatively easy, safe and simple manner.

Preferably, the winching device of trailer hitching apparatus in accordance with an embodiment of the disclosures made herein is mounted on the tow vehicle. However, it is contemplated herein that, in some embodiments of the disclosures made herein, the winching device can be mounted on the trailer. In such embodiments, the cable passes through the receiver stub of the trailer hitch, through the receiver stub opening of the receiver tube and is connected to the trailer hitch receiving assembly or to the chassis of the vehicle. In this manner, an apparatus having such an arrangement is capable of providing trailer hitching functionality in accordance with the disclosures made herein.

An apparatus in accordance with embodiments of the disclosures made herein is designed to facilitate connecting a trailer to a towing hitch. In doing so, such an apparatus provides a user with a wider margin of error when backing a tow vehicle up to a trailer to make a connection. Installation of such an apparatus requires the investment of time and money. However, once installed, such an apparatus is relatively simple and inexpensive to operate. Furthermore, it is capable of being operated by a single person with minimal physical exertion and use of time.

Apparatuses in accordance with embodiments of the disclosures made herein are capable of being fabricated using known fabrication techniques and commercially available materials. For example, steel tubing is a preferred choice for the major components of a trailer hitch receiver assembly and trailer hitch. Such major components may be fabricated using know operations such as cutting, drilling, welding and bending.

It will be apparent to those skilled in the art that many changes and substitutions can be made to the embodiments of the invention herein described without departing from the spirit and scope of the invention as defined by the appended claims and their full scope of equivalents.

I claim:

1. A trailer hitching apparatus for use with a motor vehicle to facilitate towing a trailer, the apparatus comprising:
a trailer hitch receiver assembly mounted to the vehicle and including a receiver tube having a first end, a second end, an opening at the second end, and a passage extending from the opening toward the first end;
a winching device mounted to the vehicle;
a trailer hitch receiver stub; and
a cable having a first end thereof attached to the winching device and a second end attached to the trailer hitch receiver stub, wherein at least one of the second end of the receiver tube and the trailer hitch receiver stub is tapered for easing the trailer hitch receiver stub in the second end of the receiver tube and pulling the trailer hitch receiver stub into the passage of the receiver tube.

2. The apparatus of claim 1 wherein the trailer hitch receiver stub and the second end of the receiver tube are each tapered.

3. The apparatus of claim 1 wherein a first portion of the receiver tube is aligned with the length of the vehicle and a second portion of the receiver tube extends at a non-zero angle relative to the first portion.

4. The apparatus of claim 3 further comprising a pulley for guiding the cable from the first portion of the receiver tube to the second portion of the receiver tube.

5. The apparatus of claim 1 wherein the trailer hitch receiver stub is tapered at one end and the cable extends into the tapered end of the trailer hitch receiver stub and is secured to a cable pin therein.

6. The apparatus of claim 5 wherein the trailer hitch receiver stub includes at least one clevis pin hole for securing the trailer hitch receiver stub within the receiver tube, and wherein the cable pin for securing the cable to the trailer hitch receiver stub is located between the tapered end of the trailer hitch receiver stub and the clevis pin hole.

7. In a vehicle of the type used for towing a trailer, the improvement therein comprising:
a trailer hitching apparatus mounted to the vehicle and including a trailer hitch receiver assembly having a receiver tube, a trailer hitch receiver stub, a winch, and a cable attached to the winch and also to the trailer hitch receiver stub for drawing the trailer hitch receiver stub into the receiver tube to allow an operator of the motor vehicle to attach the trailer hitch receiver stub to a trailer and then to operate the winch to draw the trailer hitch receiver stub into the receiver tube, whereupon the trailer hitch receiver stub can be further secured therein.

8. The improvement of claim 7 wherein the receiver tube has a tapered end for receiving and guiding the trailer hitch receiver stub therein.

9. The improvement of claim 7 wherein the trailer hitch receiver stub is tapered for facilitating engagement with the receiver tube.

10. The improvement of claim 7 wherein both the trailer hitch receiver stub and the receiver tube are tapered for facilitating engagement of the trailer hitch receiver stub within the receiver tube.

11. The improvement of claim 7 wherein the trailer hitch receiver stub is tapered and includes at least one clevis pin hole for securing the trailer hitch receiver stub within the receiver tube, and wherein the cable is secured to the trailer hitch receiver stub at a point located between the tapered end of the trailer hitch receiver stub and the clevis pin hole.

12. A method attaching a trailer to a trailer hitch on a vehicle, the method comprising:
providing a receiver hitch and a winch on the vehicle, the receiver hitch including a receiver tube and a receiver stub connected to the winch;
operating the winch to extend the receiver stub away from the receiver tube;
connecting the receiver stub to the trailer;
operating the winch to draw the receiver stub into the receiver tube; and
securing the receiver stub in the receiver tube with a pin.
